(19) United States
(12) Patent Application Publication
(10) Pub. No.: US 2005/0113540 A1
(43) Pub. Date: May 26, 2005

(54) Linear ethylene/vinyl alcohol and ethylene/vinyl acetate polymers and process for making same

(76) Inventors: John D. Weaver, Lake Jackson, TX (US); William J. Harris, Lake Jackson, TX (US); Stephen E. Hill, Angleton, TX (US); Yunwa W. Cheung, Lake Jackson, TX (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/507,468

(22) PCT Filed: Mar. 11, 2003
(86) PCT No.: PCT/US03/07456

Related U.S. Application Data
(60) Provisional application No. 60/363,434, filed on Mar. 12, 2002.

(51) Int. Cl. C08F 32/00

(52) U.S. Cl. 526/308

(57) ABSTRACT

A polymer comprises a repeating unit of ethylene and vinyl alcohol, characterized by a linear backbone with substantial absence of branching on the backbone. The polymer has a steady state oxygen permeability coefficient substantially independent of the humidity. In addition, a polymer comprises a repeating unit of ethylene and vinyl acetate, characterized by a linear backbone with substantial absence of branching on the backbone and a plurality of acetate groups bonded to the backbone. Some polymers comprise vinyl alcohol or acetate groups that arm separated by x-2, x-1 or x carbon atoms, and such groups are present in a ratio of 1:2:1, wherein x ranges integrally from 3 to 12.

### FIELD OF THE INVENTION

This invention pertains to polymers and polymerization processes. More specifically, the invention relates to copolymers of ethylene vinyl alcohol and ethylene vinyl acetate copolymers and their methods of manufacture.

### BACKGROUND OF THE INVENTION

Copolymers of ethylene and vinyl alcohol (EVOH) or vinyl acetate (EVA) are widely used commercially. For instance, EVA polymers constitute the world's largest volume ethylene copolymer. It may be used to form molded parts, drive belts and hoses, as well as footwear components, high-temperature insulation and adhesives. A variety of EVA copolymers may be produced on a commercial scale by the same high-pressure free-radical processes used to prepare low-density polyethylene. Importantly, the random nature of the polymerization allows the copolymer composition to be controlled by the monomer feed rate ratio. Thus, EVA copolymers may be prepared with tailored amounts of vinyl acetate. While such factors are excellent for tailoring the copolymer properties to practical applications, the properties of such polymers are also controlled by the free radical nature of their preparation.

EVA copolymers may be converted to EVOH copolymers through post-polymerization hydrolysis. The polymer microstructure produced by the EVA copolymer polymerization processes is passed on to the EVOH copolymer products. The microstructures of such free radical polymerization products possess irregular chain branches and broad polydispersities caused by both intramolecular and intermolecular chain transfer events. While chain branching is often beneficial for processing, branching can affect strength, optical clarity, crystallinity, melting temperatures, glass transition temperatures, and thermal stability.

In contrast, linear or substantially linear polyethylene can be produced by a variety of methods. For example, single-site catalysts used in these processes produce homogeneous polymers with improved repeat unit identity and significantly reduced chain branching. However, single-site catalysts have not been successfully used to copolymerize ethylene and vinyl acetate (or vinyl alcohol) due to the polar nature of the comonomers. Therefore, it would be desirable to devise a method for making linear EVA copolymers or EVOH copolymers. For the foregoing reasons, there is a need for a linear EVOH copolymer and/or EVA copolymer and methods of making such polymers.

### SUMMARY OF THE INVENTION

Some embodiments are directed to a polymer comprising repeating units of ethylene and vinyl alcohol, characterized by (a) a linear backbone with substantial absence of branching on the backbone and (b) a steady state oxygen permeability coefficient substantially independent of the humidity, a strain hardening region, or a combination thereof. In some embodiments, the polymer has a plurality of hydroxyl groups bonded to the backbone, the hydroxyl groups being separated by x-2, x-1 or x carbon atoms and present in a ratio of 1:2:1, wherein x ranges integrally from 3 to 12. In some embodiments, the polymer is a copolymer consisting essentially of repeating units of ethylene and vinyl alcohol.

Also disclosed is a polymer comprising repeating units of ethylene and vinyl acetate, characterized by (a) a linear backbone with substantial absence of branching on the backbone, (b) a plurality of acetate groups bonded to the backbone, the acetate groups being separated by x-2, x-1 or x carbon atoms and present in a ratio of 1:2:1, wherein x is an integer equal to or greater than 3. In some embodiments, the ethylene vinyl acetate polymer has tensile properties characterized by a strain hardening region. In some embodiments, the polymer is a copolymer consisting essentially of repeating units of ethylene and vinyl acetate.

In some embodiments the polymers have a vinyl alcohol or vinyl acetate content of about 1 mol. % to about 75 mol. %. Some polymers have a molecular weight distribution of less than 5. Other ethylene vinyl alcohol or ethylene vinyl acetate polymers have a molecular weight distribution of less than 3. In some embodiments the polymers have a molecular weight distribution of less than 2.

Embodiments of the ethylene vinyl alcohol or ethylene vinyl acetate polymers have characteristic oxygen transport properties. Some polymers have an oxygen permeability coefficient of less than 10 cc*mil/100 in²*day*atm or less than 8 cc*mil/100 in²*day*atm.

Some polymers are also characterized by the amount of long chain branching along the polymer backbone. In some embodiments, the polymer backbone has less than about 0.01 long-chain branch/1000 carbon atoms.

In other embodiments, the ethylene vinyl alcohol or ethylene vinyl acetate polymers may have unique tensile properties. Some of the ethylene vinyl alcohol or ethylene vinyl acetate polymers are characterized by an elongation at break of greater than about 100%. Some polymers are characterized by a maximum load of greater than about 4200 psi or an energy to break of greater than about 50 lb*in.

Some polymers have useful or characteristic thermal properties. For instance, in some embodiments, the polymers have a decomposition temperature of greater than about 305° C. Thus, such may be useful in high temperature applications. Other polymers may be characterized by a glass transition temperature of less than about −30°.

Also disclosed is a process for making a linear polymer of ethylene an vinyl alcohol, comprising (a) contacting an unsubstituted cycloolefin with a compound represented by formula I: 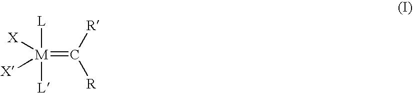
to make a precursor polymer having olefinic unsaturation wherein M is selected from the group consisting of Os and Ru;
R and R′ are independently selected from the group consisting of hydrogen and a substituent group selected from the group consisting of C₁-C₂₀ alkyl, C₂-C₂₀ alkenyl, C₂-C₂₀ alkoxycarbonyl, aryl, C₁-C₂₀ carboxylate, C₁-C₂₀ alkoxy, C₂-C₂₀ alkenyloxy, C₂-C₂₀ alkynyloxy and aryloxy; the substituent group optionally substituted with a moiety selected from the group consisting of C₁-C₅ alkyl, halogen, C₁-C₅ alkoxy, and phenyl; the phenyl optionally substituted with a moiety selected from the group consisting of halogen, C₁-C₅ alkyl, and C₁-C₅ alkoxy;
X and X′ are independently selected from any anionic ligand; and
L and L′ are independently selected from any phosphine of the formula PR³R⁴R⁵, wherein R³ is selected from the group consisting of neophyl, secondary alkyl and cycloalkyl, and R⁴ and R⁵ are independently selected from the group consisting of aryl, neophyl, C₁-C₁₀ primary alkyl, secondary alkyl, and cycloalkyl.

The process also includes (b) contacting the precursor polymer with a boron-containing compound capable of hydroborating the olefinic unsaturation to form an intermediate polymer and (c) contacting the intermediate polymer with a mixture comprising an oxidizing agent to produce a polymer comprising repeating units of ethylene and vinyl alcohol. Optionally the process further includes (d) converting the ethylene vinyl alcohol polymer to an ethylene vinyl acetate polymer.

In certain embodiments, the cycloolefin has from 3 to about 10 carbon atoms per molecule. Whatever cycloolefin is employed, one useful the boron-containing compound for the process is 9-borabicyclo[3.3.1]nonane. However, other compounds performing substantially the same function may also be used. In some embodiments of the process the oxidizing agent is oxidizing agent is hydrogen peroxide. In some embodiments the oxidizing agent optionally also includes a hydroxide source.

In some embodiments the process provides an ethylene vinyl alcohol polymer with a plurality of hydroxyl groups bonded to the backbone of the polymer, the hydroxyl groups being separated by x-2, x-1 or x carbon atoms, and being present in a ratio of 1:2:1, wherein x ranges integrally from 3 to about 12. Some embodiments of the process also provide an ethylene vinyl alcohol polymer has a steady state oxygen permeability coefficient substantially independent of the humidity. In some embodiments of the process where an ethylene vinyl acetate polymer is desired, embodiments of the process include contacting ethylene vinyl alcohol polymer with acetic anhydride to convert the vinyl alcohol groups to vinyl acetate groups.

### BRIEF DESCRIPTION OF THE DRAWINGS

FIG. 1 shows a schematic representation of one embodiment of a method of manufacturing certain ethylene vinyl alcohol and ethylene vinyl acetate polymers;

FIG. 2 illustrates the carbon-13 nuclear magnetic resonance spectrum of an exemplary precursor polymer (including solvent);

FIG. 3 illustrates the relative positions and statistical distribution of vinyl alcohol functionalities in embodiments of ethylene vinyl alcohol;

FIG. 4 illustrates the Differential Scanning Calorimetry (DSC) behavior of a linear ethylene vinyl alcohol polymer according to an embodiment of the invention and that of branched ethylene vinyl alcohol polymer samples;

FIG. 5 illustrates the Thermogravimetric Analysis (TGA) behavior of a linear ethylene vinyl alcohol polymer according to an embodiment of the invention and that of branched ethylene vinyl alcohol polymer samples;

FIG. 6 illustrates the stress strain behavior for an inventive linear ethylene vinyl alcohol polymer and a comparative branched sample;

FIG. 7 illustrates the oxygen permeability coefficient for an inventive linear ethylene vinyl alcohol polymer and comparative branched samples;

FIG. 8 is an infrared spectrum for an inventive linear ethylene vinyl alcohol polymer;

FIG. 9 illustrates the molecular weight distribution (MWD) for an inventive linear ethylene vinyl acetate polymer and for a comparative branched sample;

FIG. 10 illustrates the DSC behavior for an inventive ethylene vinyl acetate polymer and a comparative branched sample;

FIG. 11 illustrates the storage modulus (G′) as a function of temperature for an inventive ethylene vinyl acetate polymer, a comparative branched sample, and an ethylene octene copolymer;

FIG. 12 illustrates the tan δ value as a function of temperature of an inventive linear ethylene vinyl acetate polymer and that of a comparative branched sample;

FIG. 13 illustrates the glass transition temperature for a linear ethylene vinyl acetate polymer, a comparative branched sample and literature values for ethylene vinyl acetate polymers as a function of vinyl acetate content;

FIG. 14 illustrates the melt viscosity as a function of shear frequency for an inventive linear ethylene vinyl acetate polymer and a comparative branched sample; and

FIG. 15 is an infrared spectrum for an inventive linear ethylene vinyl acetate polymer.

### DESCRIPTION OF EMBODIMENTS OF THE INVENTION

In the following description, all numbers disclosed herein are approximate values, regardless whether the word “about” or “approximately” is used in connection therewith. They may vary by up to 1%, 2%, 5%, or sometimes 10 to 20%. Whenever a numerical range with a lower limit, R_{L}, and an upper limit R_{U}, is disclosed, any number R falling within the range is specifically disclosed. In particular, the following numbers R within the range are specifically disclosed: R=R_{L}+k*(R_{U}−R_{L}), wherein k is a variable ranging from 1% to 100% with a 1% increment, i.e. k is 1%, 2%, 3%, 4%, 5%, . . . , 50%, 51%, 52%, . . . , 95%, 96%, 97%, 98%, 99%, or 100%. Moreover, any numerical range defined by two numbers, R, as defined in the above is also specifically disclosed.

We have discovered a new family of linear ethylene vinyl alcohol copolymers (“EVOH copolymer”) and a method of making the copolymers. These new copolymers are characterized by a linear backbone with substantial absence of branching on the backbone. Moreover, the EVOH copolymers have a steady state oxygen permeability coefficient substantially independent of the humidity. The oxygen permeability coefficient is preferably measured in accordance with ASTM D3985-81. In some embodiments, the copolymers have hydroxyl groups bonded to the backbone, the hydroxyl groups are separated by x-2, x-1 or x carbon atoms, wherein the number of hydroxyl groups being separated by x-2, x-1, and x carbon atoms is about 1:2:1, wherein x is any integer equal to or greater than 3, preferably from about 3 to about 12. For example, the hydroxyl groups in an EVOH copolymer with about 25 mol. % of vinyl alcohol are separated by 6, 7, or 8 carbon atoms along the backbone and are present in a ratio of 1:2:1.

In addition, a new family of ethylene vinyl acetate copolymers (“EVA copolymer”) and a method of manufacture are provided. The new EVA copolymers are characterized by a linear backbone with substantial absence of branching on the backbone. In some embodiments, the acetate groups are separated by x-2, x-1 or x carbon atoms. The ratio of acetate groups being at the x-2, x-1, and x positions is about 1:2:1, wherein x is any integer equal to or greater than 3, preferably from about 3 to about 12.

The term “polymer” as used herein refers to a macromolecular compound prepared by polymerizing monomers of the same or a different type. A polymer refers to homopolymers, copolymers, terpolymers, interpolymers, and so on. The term “interpolymer” used herein refers to polymers prepared by the polymerization of at least two types of monomers or comonomers. It includes, but is not limited to, copolymers (which usually refers to polymers prepared from two different monomers or comonomers), terpolymers (which usually refers to polymers prepared from three different types of monomers or comonomers), and tetrapolymers (which usually refers to polymers prepared from four different types of monomers or comonomers), and the like. The terms “an ethylene vinyl alcohol polymer” and “an ethylene vinyl acetate polymer” as used herein should be understood to include any polymeric material that comprises a repeating unit derived from ethylene and vinyl alcohol or ethylene and vinyl acetate, respectively. Although in some embodiments, the repeating units may be derived from methylene and vinyl alcohol or vinyl acetate. Thus, while the polymers described herein may not actually be copolymerized from ethylene and vinyl alcohol or vinyl acetate monomers, they are nevertheless considered as copolymers of ethylene and vinyl alcohol or ethylene and vinyl acetate. Thus, the description of the ethylene and vinyl alcohol or vinyl acetate portions of a final polymer may be referred to as comonomer portions, or simply as comonomers, despite the fact that ethylene and vinyl alcohol or vinyl acetate monomers are not used in the preparation of the polymer. Of course, such a description also applies to polymers made by the copolymerization of ethylene and vinyl alcohol or vinyl acetate. An ethylene vinyl alcohol or vinyl acetate polymer may further comprise a third, fourth, fifth monomer or comonomer (other than vinyl alcohol or vinyl acetate).

As mentioned above, the polymers of ethylene and vinyl alcohol and ethylene and vinyl acetate have a linear polymer backbone. As used herein the term “linear” means that the polymer backbone is substantially free of branching. The terms “substantially free of branching” and “a substantial absence of branching” mean that the polymer backbone is either not substituted with branches or is substituted with no more than 3 branches per 1000 carbon atoms. “Substantial absence of branching” may also mean that the polymer backbone has no more than 2, no more than 1 , no more than 0.1 or no more than 0.01 branches per 1000 carbon atoms. In some embodiments, the polymer backbone has no more than 0.005 branch per 1000 carbon atoms, no more than 0.001 branch per 1000 carbon atoms, no more than 0.0005 branch per 1000 carbon atoms, no more than 0.0001 branch per 1000 carbon atoms, or no more than 0.00001 branch per 1000 carbon atoms. Additionally, the terms “branching” and “branches” as used herein do not include hydroxyl and acetate groups.

One kind of branching is short chain branching. Short chain branches are branches having a chain length of less than 6 carbon atoms, or a chain length which can be determined by ¹³C nuclear magnetic resonance. As mentioned previously, short chains due to comonomers is not considered as “branching.” The homogeneity of the polymers is typically described by the SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described, for example, in Wild, et al, Journal of Polymer Science, Poly. Phys. Ed., Vol. 20, p. 441 (1982), in U.S. Pat. No. 4,798,081 (Hazlitt, et al.), or in U.S. Pat. No. 5,089,321 (Chum, et al.) the disclosures of all of which are incorporated herein by reference. The SCBDI or CDBI for the ethylene vinyl alcohol and ethylene vinyl acetate polymers herein may be greater than about 30 percent. Some embodiments may have a SCBDI greater than about 50 percent. Certain inventive polymers may have a SCBDI greater than about 90%, about 95%, or about 99%. Other ethylene vinyl alcohol and ethylene vinyl acetate polymers described herein may have substantially the same ethylene/comonomer ratio in each polymer molecule.

Another form of branching is called long chain branching. Long chain branching is defined herein as a branch from the polymer backbone having a chain length of at least about 6 carbon atoms, or a chain length above which the chain length cannot be distinguished using ¹³C nuclear magnetic resonance. Sometimes, the long chain branches may be as long as about the length of the polymer backbone. In some embodiments long chain branches have at least about 1 carbon atom more than any residuals left over by an α-olefin comonomer. Long chain branching is determined by ¹³C NMR spectroscopy and is quantified using the method of Randall (Rev. Macromol. Chem. Phys., C29 (2&3), p. 285-297), the disclosure of which is hereby incorporated by reference.

In addition to being characterized by the substantial absence of long chain branches, some ethylene vinyl alcohol and ethylene vinyl acetate polymers herein also have other unique structural characteristics. For instance, the hydroxyl groups or the acetate groups have a statistically random configuration. Such polymers have a structure wherein the vinyl alcohol groups or the vinyl acetate groups are bonded to the backbone and are separated by x-2, x-1 or x carbon atoms where x is the number of carbon atoms of the cyclic olefin, and the relative ratio of the groups separated by x-2, x-1 and x carbon atoms is 1:2:1 in which x is any integer equal to or greater than 3. In some embodiments, x is about 3 to about 12. In other embodiments x may be greater than 12.

The linear ethylene vinyl alcohol polymer can be made by a variety of methods. For example, one method includes contacting an unsubstituted cycloolefin with a metal-containing compound to make a precursor polymer having olefinic unsaturation. The process also includes contacting the precursor polymer with a boron-containing compound capable of hydroborating the olefinic unsaturation to form an intermediate polymer and contacting the intermediate polymer with a mixture comprising an oxidizing agent to produce an ethylene vinyl alcohol polymer. In some embodiments, the method further includes converting an ethylene vinyl alcohol polymer to an ethylene vinyl acetate polymer by acetylation of the hydroxyl groups.

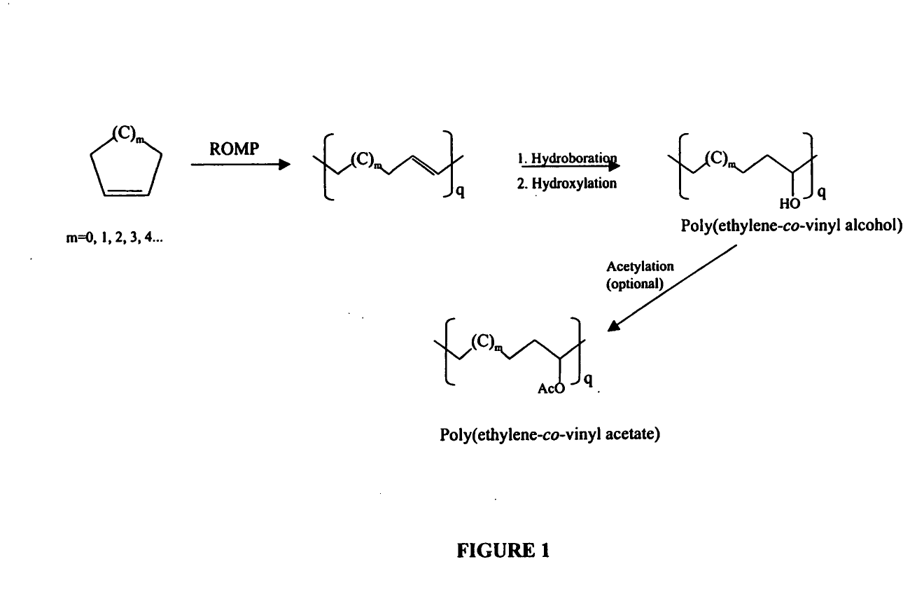

One method of making polymers with the properties and structure described above is schematically represented in FIG. 1. An unsubstituted cycloolefin with (m+4) carbon atoms per molecule undergoes a ring opening polymerization to form a precursor polymer whose backbone comprises (m+4) carbon atoms per repeating unit, wherein m is zero or any positive integer, such as 1, 2, 3, 4, 5, 6, 7, 8, 9, 10, 11, 12, 13, 14, 15, and so on. As such, suitable cycloolefins include, but are not limited to, cyclobutene, cyclopentene, cyclohexene, cyclooctene, cyclononene, and cyclodecene. Although unstable at ambient conditions, cyclopropylene may also be used if desired. While FIG. 1 depicts one unsubstituted cycloolefin, two or more cycloolefins of different ring sizes may be used in some embodiments.

In some embodiments, precursor polymers can be considered homopolymers of a cycloolefin. The precursor polymer undergoes hydroboration and hydroxylation reactions to form a polymer which can be considered as ethylene/vinyl alcohol copolymer, wherein the vinyl alcohol monomer is present in

$$100 \times \frac{2}{m + 4} mol . \% .$$

Therefore, by adjusting m, one may obtain an EVOH copolymer with the vinyl alcohol content ranging from about 1mol. % to about 75 mol. %. For example, using a cyclobutene, it is possible to obtain an EVOH copolymer with 50 mol. %. Similarly, using a cyclooctene, one may obtain an EVOH copolymer with 25 mol. % by using two or more cycloolefins of different ring size, it is possible to obtain other vinyl alcohol contents. As such, this process can produce a series of EVOH copolymers with varying contents of vinyl alcohol. These EVOH copolymers may, in turn, be converted to EVA copolymers with varying contents of vinyl acetate.

Referring to FIG. 1, the method includes a controlled ring-opening metathesis polymerization (ROMP) process. The ROMP polymerization reaction for converting the unsubstituted cycloolefin to the precursor polymer is generally carried out in an inert atmosphere by dissolving a catalytic amount of a carbene catalyst in a solvent and adding the unsaturated cycloolefin, optionally dissolved in a solvent, to the carbene solution. The polymerization mixture may be agitated, if necessary. The progress of the polymerization may be monitored by techniques known in the art for monitoring such reactions, such as nuclear magnetic resonance spectroscopy. The cycloolefin is contacted with the metal-containing catalyst in a solvent at a temperature and pressure sufficient to initiate the polymerization. Preferably the polymerization temperature may ranges from about 0° C. to about the boiling point of the solvent. Suitable solvents include aliphatic and aromatic liquids. Exemplary solvents include but are not limited to inorganic, aprotic, or aqueous solvents which are inert under the chosen reaction conditions such as: aromatic hydrocarbons, alcohols, water, chlorinated hydrocarbons, ethers, aliphatic hydrocarbons, or mixtures thereof Specific solvents include tetrahydrofuran (THF), cyclohexane, methyl cyclohexane, pentane, hexane, heptane, diethyl ether, benzene, toluene, p-xylene and mixtures thereof. In certain embodiments, the solvent may be a halogenated hydrocarbon, such as unstabilized dichloromethane, dichloroethane, dichlorobenzene, or chlorobenzene and mixtures thereof.

Any catalyst that can initiate ring-opening metathesis polymerizations may be used. Exemplary suitable catalysts include metal-containing carbene catalysts corresponding to the following formula: 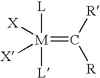
wherein M is selected from the group consisting of Os and Ru;
R and R′ are independently selected from the group consisting of hydrogen and a substituent group selected from the group consisting of C₁-C₂₀ alkyl, C₂-C₂₀ alkenyl, C₂-C₂₀ alkoxycarbonyl, aryl, C₁-C₂₀ carboxylate, C₁-C₂₀ alkoxy, C₂-C₂₀ alkenyloxy, C₂-C₂₀ alkynyloxy and aryloxy, alkylsulinyl, alkylthio, C₁-C₂₀ cycloalkyl, C₁-C₂₀ cycloalkoxy, and diketonates; the substituent group optionally substituted with a moiety selected from the group consisting of C₁-C₅ alkyl, halogen, C₁-C₅ alkoxy, and phenyl; the phenyl optionally substituted with a moiety selected from the group consisting of halogen, C₁-C₅ alkyl, and C₁-C₅ alkoxy;
X and X′ are independently selected from any anionic ligand; and
L and L′ are independently selected from any phosphine of the formula PR³R⁴R⁵, wherein R³ is selected from the group consisting of secondary alkyl and cycloalkyl, and R⁴ and R⁵ are independently selected from the group consisting of aryl, C₁-C₁₀ primary alkyl, secondary alkyl, and cycloalkyl.

With regard to ligands R and R′:
alkenyl can include vinyl, 1-propenyl, 2-propenyl; 3-propenyl and different butenyl, pentenyl and hexenyl isomers, 1,3-hexadienyl and 2,4,6-heptatrienyl, and cycloalkenyl;
alkenyloxy can include H₂C═CHCH₂O, (CH₃)₂C═CHCH₂O, (CH₃)CH═CHCH₂O, (CH₃)CH═C(CH₃)CH₂O and CH₂═CHCH₂CH₂O;
alkoxy can include methoxy, ethoxy, n-propyloxy, isopropyloxy and different butoxy, pentoxy and hexyloxy isomers;
cycloalkoxy can include cyclopentyloxy and cyclohexyloxy;
alkoxyalkyl can include CH₃OCH₂, CH₃OCH₂CH₂, CH₃CH₂OCH₂, CH₃CH₂CH₂OCH₂ and CH₃CH₂OCH₂CH₂; and alkoxycarbonyl can include CH₃OC(═O); CH₃CH₂OC(═O), CH₃CH₂CH₂OC(═O), (CH₃)₂CHOC(═O) and the different butoxy-, pentoxy- or hexyloxycarbonyl isomers;
alkyl can include methyl, ethyl, n-propyl, i-propyl, or the several butyl, pentyl or hexyl isomers and cycloalkyl isomers;
alkylsulfnyl can include CH₃SO, CH₃CH₂SO, CH₃CH₂CH₂SO, (CH₃)₂CHSO and the different butylsulfiyl pentylsulfnyl and hexylsulfiyl isomers;
alkylthio can include methylthio, ethylthio and the several prophylthio butylthio, pentylthio, and hexylthio isomers;
alkynyl can include ethynyl, I-propynyl, 3-propynyl and the several butynyl pentynyl and hexynyl isomers, 2,7-octadiynyl and 2,5,8-decatriynyl;
alkynyloxy can include HC═CCH₂O, CH₃C═CCH₂O and CH₃C═CCH₂OCH₂O;
aryl can include phenyl, p-tolyl and p-fluorophenyl;
carboxylate can include CH₃CO₂CH₃CH₂CO₂, C₆H₅CO₂, (C₆H₅)CH₂CO₂;
cycloalkyl can include cyclopentyl and cyclohexyl;
cycloalkenyl can include cyclopentenyl and cyclohexenyl;
diketonates can include acetylacetonate and 2,4-hexanedionate;
halogen or halide, either alone or in compound words such as haloalkyl, denotes fluorine, chlorine, bromine or iodine;
the anionic ligands X and X′ may be any ligand which when removed from a metal center in its closed shell electron configuration has a negative charge. Carbene compounds in the presence of ruthenium or osmium in the +2 oxidation state (the carbene fragment is considered to be neutral), have an electron count of 16 and pentacoordination. A wide variety of anionic ligands, X and X′ can be used where the carbene compound still exhibits catalytic activity.

In some embodiments, R and R′ are independently selected from hydrogen, vinyl, C₁-C₁₀ alkyl, aryl, C₁-C₁₀ carboxylate, C₂-C₁₀ alkoxycarbonyl, C₁-C₁₀ alkoxycarbonyl, C₁-C₁₀ alkoxy, aryloxy, each optionally substituted with C₁₀-C₅ alkyl, halogen, C₁-C₅ alkoxy or with a phenyl group optionally substituted with halogen, C₁-C₅ alkyl or C₁-C₅ alkoxy; and
X and X′ are independently selected from halogen, hydrogen, diketonates, or C₁-C₂₀ alkyl, aryl, C₁-C₂₀ alkoxide, aryloxide, C₂-C₂₀ alkoxycarbonyl, arylcarboxylate, C₁-C₂₀ carboxylate, arylsulfonate or C₁-C₂₀ alkylsulfonate, C₁-C₂₀ alkylthio, each optionally substituted with C₁-C₅ alkyl, halogen, C₁-C₅ alkoxy or with a phenyl group optionally substituted with halogen, C₁-C₅ alkyl or C₁-C₅ alkoxy.

In other embodiments, R and R′ are independently selected from hydrogen;
vinyl, C₁-C₅ alkyl, phenyl, C₁-C₅ alkoxycarbonyl, C₁-C₅ carboxylate, C₁-C₅ alkoxy, phenoxy; each optionally substituted with C₁-C₅ alkyl, halogen, C₁-C₅ alkoxy or a phenyl group optionally substituted with halogen, C₁-C₅ alkyl or C₁-C₅ alkoxy; and
X and X′ are independently selected from Cl, Br, L or benzoate, acetylacetonate, C₁-C₅ carboxylate, C₁-C₅ alkyl, phenoxy, C₁-C₅ alkythio, aryl, and C₁-C₅ alkyl sulfonate; each optionally substituted with C₁-C₅ alkyl or a phenyl group optionally substituted with halogen, C₁-C₅ alkyl or C₁-C₅ alkoxy.

In still other embodiments, R and R′ are independently vinyl, H, Me, Ph; and
X and X′ are independently Cl, CF₃CO₂, CH₃CO₂, CFH₂CO₂, (CH₃)₃CO, (CF₃)₂(CH₃)CO, (CF₃)(CH₃)₂CO, PhO, MeO, EtO, toslate, mesylate, or trifluoromethanesulfonate.

The carbene complexes have a well-defined ligand environment which enables flexibility in modifying and fine tuning the activity level, stability, solubility and ease of recovery of these catalysts. The electron-donating ability of the neutral electron-donating ligands L and L′ of the carbene complexes influences the activity of the catalyst. By using more electron-donating alkyl substituents on the phosphines, one is able to conduct less energetically favored reactions, such as ROMP reactions on non-strained cycloalkenes and ring-closing metathesis reactions of acyclic dienes. By contrast, less reactive carbene catalysts, such as where L and L′ are P(Ph)₃, are preferred in instances where selectivity of strained over unstrained alkenes is desired.

The solubility of the carbene compounds may be controlled by proper selection of either hydrophobic or hydrophilic ligands. The desired solubility of the catalyst is determined by the solubility of the reaction substrates and reaction products. Preferably, one should design catalysts whose solubility is distinguishable from that of the reaction substrates and products, thereby facilitating the recovery of the catalyst from the reaction mixture.

The carbene compounds, because of their higher level of metathesis activity, are able to catalyze the metathesis coupling of any two olefins. There is a very wide variety of reactions that is enabled by the ability of these carbene compounds to couple any two olefins.

In certain embodiments, all of the alkyl groups of the trialkyl phosphine, PR³R⁴R⁵, may be either secondary alkyl or cycloalkyl groups. Some catalysts include compounds where L and L′ are alkyl phosphines having a carbon backbone of at least one alkyl group is a secondary alkyl or cycloalkyl group. Substitution of the secondary alkyl and cycloalkyl with additional carbon fragments and/or other functional groups are also within the term secondary alkyl and cycloalkyl group. In other embodiments, the alkyl groups of L and L′ are isopropyl, isobutyl, sec-butyl, neopentyl, cyclopentyl or cyclohexyl.

Suitable catalyst compounds may be prepared by a variety of different methods disclosed in U.S. Pat. No. 5,312,940, No. 5,849,851 and No. 5,342,909, which are incorporated herein by reference.

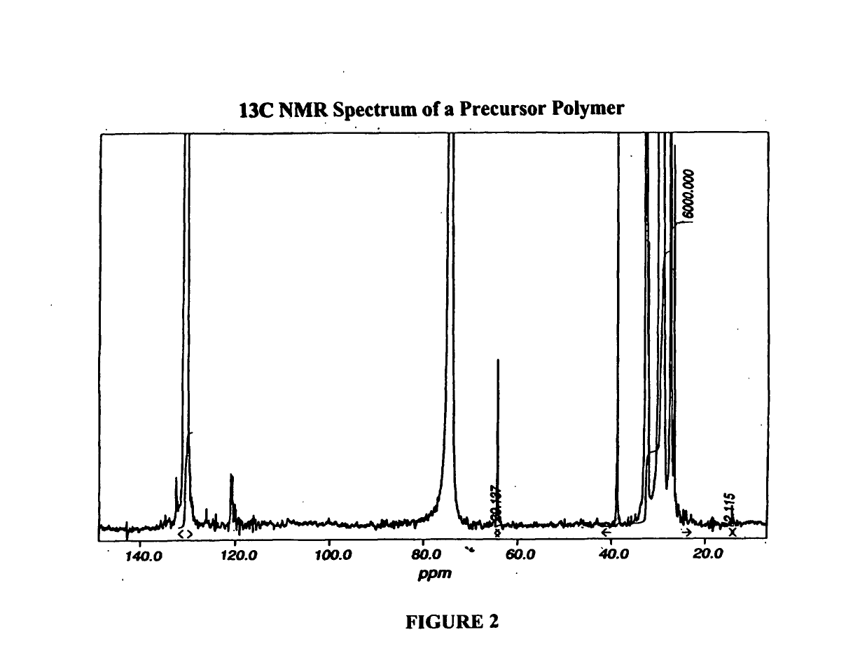

In the process, the metal-containing carbene catalyst employed in the ROMP process produces a precursor polymer which has olefinic unsaturations. FIG. 2 illustrates the ¹³C-nuclear magnetic resonance spectrum of one such precursor polymer.

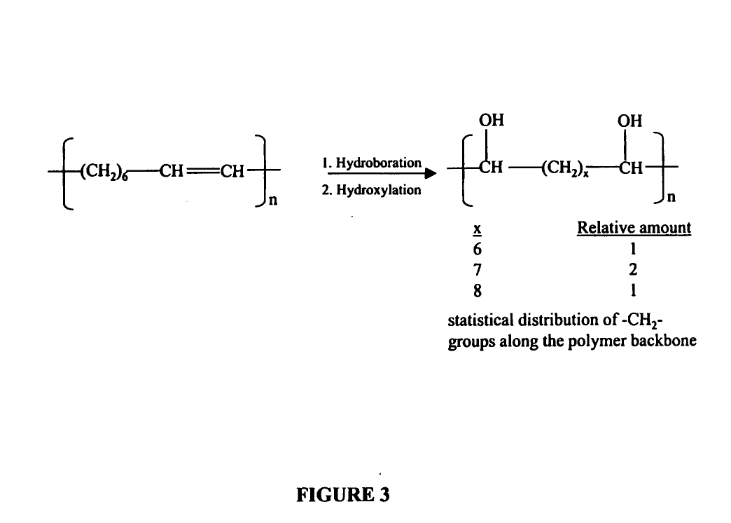

Upon hydroboration and hydroxylation, the precursor polymer is converted to an ethylene/vinyl alcohol copolymer. The hydroxyl groups of the copolymer can be acetylated to obtain an ethylene/vinyl acetate copolymer. Because the hydroboration and hydroxylation reactions occur randomly at the olefinic unsaturations, the hydroxyl groups are randomly distributed throughout the backbone of the copolymer. As illustrated in FIG. 3, an exemplary precursor polymer prepared from cyclooctene and having 8 carbon atoms per repeat unit may then undergo a hydroboration and hydroxylation processes to yield an inventive ethylene vinyl alcohol polymer in which the vinyl alcohol functionalities are separated by either 6, 7, or 8, carbon atoms in the polymer chain. The relative number of vinyl alcohol functionalities separated by 6, 7, or 8 carbon atoms is 1:2:1, respectively. Generally, an unsubstituted cycloolefin with x carbon atoms would lead to a polymer which would have hydroxyl (or acetate groups) be separated by x, x-1, and x-2 carbons, wherein hydroxyl (or acetate) groups are present in a 1:2:1 ratio. However, if two or more cycloolefins of different ring size are used, this relationship might not be present.

If a particular molecular weight polymer is desired, a chain transfer agent may be added to the polymerization solvent. As a general rule, greater concentrations of chain transfer agent generally yields lower molecular weight polymers. In some embodiments of the invention, the chain transfer agent is 3-hexene and the number average molecular weight ranges from about 100,000 to about 200,000. Alternatively, the reaction is terminated by deactivating the catalyst. Any deactivating agent may be used. An example of the deactivating agent is ethyl vinyl ether.

The embodiments of the invention also include converting the precursor polymer to an intermediate polymer. In certain embodiments converting the precursor polymer includes contacting the precursor polymer with a boron-containing compound capable of hydroborating the olefinic unsaturation. In certain embodiments, the compound capable of hydroborating the olefinic unsaturations of the precursor polymer is 9-borabicyclo[3.3.1]nonane (9-BBN). However, other constrained hydroboration compounds are also suitable. Additional suitable hydroboration compounds include, but are not limited to, disiamylborane, thexylborane. In addition, borane as well as its complexes and derivatives, such as diborane and monochloroborane, may be used as well. The amount of the hydroborating compound should be selected according to the desired extent of hydroboration desired in the product polymer of the hydroboration. Some embodiments employ an excess of the borabicyclo[3.3.1]nonane (9-BBN). In certain embodiments a two-fold excess of borabicyclo[3.3.1]nonane (9-BBN) is useful.

The conversion of the precursor polymer to the intermediate polymer also includes hydroxylating the hydroborated polymer. In particular embodiments, the hydroborated polymer is hydroxylated by exposure to an oxidizing mixture that includes an oxidizing agent such as hydrogen peroxide. In other embodiments the oxidizing mixture includes a source of hydroxide ions. The hydroxylation forms an ethylene vinyl alcohol polymer.

In some embodiments, the method further optionally includes converting an ethylene vinyl alcohol polymer to an ethylene vinyl acetate polymer. This conversion may be accomplished by any acetylating agent, such as acetyl chloride or acetic anhydride. However, any other compound that converts the hydroxyl group of the ethylene vinyl alcohol polymer to an acetate functionality may be used. Where the acetylation is performed by a homogeneous process, 1,4 dioxane is a suitable solvent. In some embodiments, the acetate content can also be manipulated by partially converting the alcohol to acetate, if so desired.

In other embodiments, polymers are prepared by cross-metathesis of an unsaturated polymer, such as cis-poly(1,3-butadiene), in the presence of a functional cycloolefin. Preferably, the cis-poly(1,3-butadiene) has a liner backbone, with no branches. The cross-metathesis produces a random copolymer of the unsaturated polymer and the functional cycloolefin. Details of cross-metathesis polymerizations are disclosed in “New Approaches to Olefin Cross-Metathesis,” Blackwell, H.E. et al., J. Am. Chem. Soc., 2000, vol. 122, pp. 58-71. Functional groups on the functional cycloolefin include, but are not limited to, carboxylic acid groups, aldehyde groups, ketone groups, and alcohol groups. Thus, in some embodiments, the cross-metathesis reaction produces branched polymers. Related ethylene/vinyl acetate copolymers are disclosed in “Ethylene/Vinyl Acetate Copolymers via Acyclic Diene Metathesis Polymerization. Examining the Effect of ‘Long’ Precise Ethylene Run Lengths,” Watson, M. D., et al., Macromolecules, 2000, vol. 33, pp. 5411-5417 and “Highly Efficient Syntheses of Acetoxy- and Hydroxy-Terminated Telechelic Polybutadienes Using Ruthenium Catalysts Containing N-Heterocyclic Ligands,” Bielawski, C. W., et al., Macromolecules 2000, vol. 33, pp. 1929-1935. In the event that a polymer without C═C unsaturations is desired, the metathesis catalyst is transformed into a hydrogenation catalyst as taught in U.S. Pat. No. 6,107,237 issued to Wagener, et al. Each of the above cited references is incorporated herein by reference in its entirety. In some embodiments, such catalysts fit the general formula described above with L or L′ being individually 1,3-bis(2,4,6-trimethylphenyl)-4,5-dihydroimidazol-2-ylidene or L′ and R form a fused ring of the formula (CH₃)₂CHO(C₆H₄) are useful, particularly for cross-metathesis polymerizations. In other embodiments, particularly for cross-metathesis polymerization, the catalyst is tricyclohexylphosphine[1,3-bis(2,4,6-trimethylphenyl)-4,5-dihydroimidazol-2-ylidene][benzylidene]ruthenium(IV)dichloride, available from Strem Chemicals. Other suitable catalysts are disclosed in “Utility of a Ruthenium Metathesis Catalyst for the Preparation of End-Functionalized Polybutadiene,” Hillmyer, M. A, et al., Macromolecules 1997, vol. 30, pp. 718-721.

The molecular weight of the polymers described herein may range from about 1,000 to about 1,000,000, about 5,000 to about 500,000 or about 10,000 to about 300,000. The molecular weight of the polymers herein is conveniently indicated using a melt index measurement according to ASTM D-1238, Condition 190° C./2.16 kg (formerly known as “Condition (E)” and also known as I₂). Melt index is inversely proportional to the molecular weight of the polymer. Thus, the higher the molecular weight, the lower the melt index, although the relationship is not linear. The lower melt index limit for polymers described herein is generally about 0.001 grams/10 minutes. The upper melt index limit is about 5,000 g/10 min. In some embodiments the melt index is less than about 1 g/10 min or less than about 0.5 g/10 min.

Another measurement useful in characterizing the molecular weight of the polymers is conveniently indicated using a melt index measurement according to ASTM D-1238, Condition 190° C./10 kg (formerly known as “Condition (N)” and also known as I₁₀). The ratio of the I₁₀ and I₁₂ melt index terms is the melt flow ratio and is designated as I₁₀/I₂.

The molecular weight distribution is determined by gel permeation chromatography (GPC). GPC measurements for the EVA polymers are carried out on a Waters 150 high temperature chromatographic unit equipped with three linear mixed bed columns (Polymer Laboratories, 10 micron particle size), operating at a system temperature of 140° C.). GPC measurements for the precursor polymers, such as polyoctenylene, are carried out on a Waters 150 high temperature chromatographic unit equipped with two mixed bed columns (one Mixed D and one Mixed E column). The operating temperature of the system is 140° C. for the EVA measurements and 30° C. for the precursor polymers. The solvent used in the EVA measurements is 1,2,4-trichlorobenzene, while for the precursor polymers tetrahydrofuran is used. Sample solutions with about 0.5% by weight of the polymer are prepared for injection. The flow rate for these measurements is 1.0 milliliter/minute and injection volume is 100 microliters.

The molecular weight distribution is deduced from these measurements using narrow molecular weight distribution polystyrene standards, available from Polymer Laboratories, in conjunction with their elution volumes. While one skilled in the art is familiar with such methods, they are described here for completeness. For example, equivalent polymer molecular weights are determined by employing the appropriate Mark-Houwink coefficients for the polyethylene and polystyrene (as described by Williams and Ward in Journal of Polymer Science, Polymer Letters, Vol. 6, (621) 1968, incorporated herein by reference) to derive the following equation:
M_{polyethylene}=a*(M_{polystyrene})^{b}.
In this equation a=0.4316 and b=1.0. The weight average molecular weight, M_{w}, and the number average molecular weight, Mₙ, are calculated in the usual manner according to the formula:
Mⱼ=(Σ wᵢ(Mᵢ^{j}))^{j};
where wᵢ is the weight fraction of the molecules with molecular weight Mᵢ, eluting from the GPC column in fraction i and j=1 when calculating M_{w} and j=−1 when calculating Mₙ.

The EVA polymers generally have a molecular weight distribution, determined by GPC, of less than about 5. In some embodiments, the polymers has a molecular weight distribution of less than about 3, less than about 2.5, or less than about 2.

Certain polymers are characterized by their thermal and mechanical properties. Differential Scanning Calorimetry (DSC) measurements were carried out on a TA (Dupont) DSC. Each sample was melted at 190° C. for 5 min., cooled at 10° C./min., and the conventional DSC endotherm was recorded by scanning from −60° C. to 190° C. at 10° C./min (i.e. the second heat). Dynamic mechanical properties of compression molded samples were monitored using a Rheometrics 800E mechanical spectrometer. Samples were run in solid state torsional rectangular geometry and purged under nitrogen to prevent thermal degradation. Generally, the sample was cooled to −100° C. and a strain of 0.05% was applied. Oscillation frequency was fixed at 10 rad/sec and the temperature was ramped in 5° C. increments.

Low shear rheology data were obtained at 190° C. using an RMS 800 analyzer available from Rheometrics, Inc. having 25 mm diameter parallel plates. A frequency sweep with five logarithmically spaced points per decade was run from 0.1 to 100 rad/s. The strain was determined to be within the linear viscoelastic regime by performing a strain sweep at 0.1 rad/s at 190° C., by strain sweep from 2% to 30% strain in 2% strain steps to determine the minimum required strain to produces torques within the specification the of transducer; another strain sweep at 100 rad/s and 190° C. was used to determine the maximum strain before nonlinearity occurred according to the procedure disclosed by J. M. Dealy, et al., “Melt Rheology and Its Role in Plastics Processing”, Van Nostrand, New York (1990).

Tensile properties of specimens prepared according to ASTM 1708-96. Samples were prepared by compression molding a plaque from the polymer to be tested. Typically, the sample is melted at 190° C. for 3 minutes then compression molded at about 190° C. for 2 minutes under about 5.5 MPa pressure for about 2 minutes. The plaque is then allowed to cool at about 8° C./minute while still under 200 psi pressure. The molded plaque has a thickness of about 0.005 inches. The plaque is then cut into a dogbone shaped test piece using a steel rule die according to a shape in accordance with ASTM 1708-96. Test pieces are 0.315 inches wide and 1.063 inches long. The start of the curved portion of the dogbone shape begins at 0.315 inches from each end of the sample and gently curves (i.e., tapers) to a width of 0.09 inches. The curve ends at a point 0.118 inches from the start of the curve such that the interior portion of the dogbone test piece has a width of 0.09 inches and a length of 0.197 inches.

The tensile properties of the test samples were tested on an Instron 1145 Tensile Tester at a crosshead speed of 5 inch/minute. The energy to break is the total energy under the stress-strain curve. In some embodiments the polymers herein have an energy to break of greater than about 50 in*lb. In other embodiments, polymers have an energy to break of greater than about 60 lb*in, 90 lb*in, or about 120 lb*in. In still other embodiments, polymers have an energy to break of greater than about 140 lb*in, about 150, lb*in, about 160 lb*in, about 170 lb*in or about 180 lb*in. Other polymers have energy to break that is greater or less than these values.

The slope of strain hardening is calculated from the resulting tensile curve by drawing a line parallel to the strain hardening region of the resulting stress/strain curve. The strain hardening region occurs after the sample has pulled its initial load ((i.e., stress) usually with little or no elongation during the initial load) and after the sample has gone through a slight drawing stage (usually with little or no increase in load, but with increasing elongation (i.e., strain)). In the strain hardening region, the load and the elongation of the sample both continue to increase. The load increases in the strain hardening region at a relatively lower rate than during the initial load region and the elongation also increase, again at a rate lower than that experienced in the drawing region. The slope of the parallel line in the strain hardening region is then determined.

The slope of strain hardening coefficient (SHC) is calculated according to the following equation:
SHC=(slope of strain hardening)*(I₂)^{0.25}
where I₂=melt index in grams/10 minutes. Some polymers have a slope of strain hardening coefficient of about 0.1 to about 10, preferably about 0.5 to about 5, more preferably from about 1 to about 3.

Steady state oxygen transmission rates of the EVOH and EVA polymers have been determined measured in accordance with ASTM D3985-81, the description of which is incorporated by reference herein in its entirety. This method is suitable for the determination of the transmission rate of oxygen gas through plastics in the form of a film, sheeting, laminates, coextrusions or plastic-coated papers or fabrics. The steady state oxygen transmission rate is measured after a film of the sample has equilibrated in the test environment. After equilibration, the sample is mounted as a sealed semi-barrier between two chambers at ambient pressure. One chamber is slowly purged by a mixture of nitrogen and hydrogen gases having less than 100 ppm of oxygen therein and a hydrogen content varying from 0.5 and 3.0. Generally, the second chamber contains oxygen at a concentration of not less than 99.5%. In the experiments reported herein, the first chamber contains 100% nitrogen while the second chamber contained 100% oxygen, both at atmospheric pressure. To determine the oxygen transmission rate as a function of humidity, the humidity was adjusted to be approximately equal in each chamber and by adding humidified gas to each chamber in place of dry gas. In these cases, the oxygen content is 100% minus the percentage of water associated with the relative humidity. In such cases one skilled in the art can easily calculate the percentage oxygen and the oxygen partial pressure on each side of the film. As the oxygen moves through the film, to the nitrogen-containing chamber, the oxygen is detected by a coulometric detector. The magnitude of the electric current produced in the detector is proportional to the rate of oxygen transmission.

The polymers described herein, particularly ethylene vinyl alcohol copolymers, possess a unique characteristic in that their steady state oxygen transmission rate is substantially independent of the humidity. The term “substantially independent of humidity” means that over the range of 0% humidity to 100% humidity, the oxygen permeability coefficient is within about 50% of the average oxygen permeability coefficient over the range of 0% humidity to 100% humidity. In other cases, the term means that the minimum value of the steady state oxygen permeability coefficient deviates from the maximum steady state permeability coefficient by less than about 100%, preferably less than about 95%, 75%, 55%, 35% or 15%. In certain instances, the polymers have an oxygen permeability coefficient of less than 10 cc-mil/100 in²*day*atm. In other embodiments, the oxygen permeability coefficient is less than 8 cc-mil/100 in²*day*atm.

Fabricated articles made from the novel olefin polymers may be prepared using all of the conventional polyolefin processing techniques. Useful articles include cast, blown, multilayer, and extrusion coated films; fibers, for example, staple fibers having a polymer disclosed herein as at least one component comprising at least a portion of the fiber's surface, spunbond fibers or melt blown fibers as disclosed in U.S. Pat. No. 4,430,563, U.S. Pat. No. 4,663,220, U.S. Pat. No. 4,668,566, or U.S. Pat. No. 4,322,027, all of which are incorporated herein by reference, and gel spun fibers as disclosed in U.S. Pat. No. 4,413,110, incorporated herein by reference; woven and nonwoven fabrics, such as, spunlaced fabrics disclosed in U.S. Pat. No. 3,485,706, incorporated herein by reference, or structures made from such fibers including, blends of these fibers with other fibers such as PET or cotton; and molded articles made, for example, using an injection molding process, a blow molding process or a rotomolding process. The new polymers described herein are also useful for wire and cable coating operations, as well as in sheet extrusion for vacuum forming operations.

Specific applications wherein the inventive polymers disclosed herein may be used include, but are not limited to, greenhouse films, shrink film, clarity shrink film, lamination film, extrusion coating, liners, clarity liners, overwrap film, agricultural film, high strength foam, soft foam, rigid foam, cross-linked foam, high strength foam for cushioning applications, sound insulation foam, blow molded bottles, wire and cable jacketing, including medium and high voltage cable jacketing, wire and cable insulation, especially medium and high voltage cable insulation, telecommunications cable jackets, optical fiber jackets, and frozen food packages.

The ethylene vinyl alcohol (EVOH) polymers and ethylene vinyl acetate polymers disclosed herein may also be used to form homogeneous blends. Other blends may be phase separated blends especially for improved impact toughness. Useful compositions are also suitably prepared comprising the polymers according to embodiments of the invention and at least one other natural or synthetic polymer. Preferred other polymers include, but are not limited to, thermoplastics, such as styrene-butadiene block copolymers, polystyrene (including high impact polystyrene), ethylene vinyl alcohol copolymers, ethylene acrylic acid copolymers, other olefin copolymers (especially polyethylene copolymers) and homopolymers (e.g., those made using conventional heterogeneous catalysts). Examples include polymers made by the process of U.S. Pat. No. 4,076,698, incorporated herein by reference, other linear or substantially linear polymers as described in U.S. Pat. No. 5,272,236, and mixtures thereof Other substantially linear polymers and conventional HDPE and/or LDPE may also be used in the thermoplastic compositions. Such blends can be employed to form biaxially oriented films which may also have good oxygen barrier properties. Certain ethylene vinyl acetate or ethylene vinyl alcohol polymers and their blends are also useful as heat sealable barriers in multilayer films. They may also serve as hot water and superheated steam resistant barrier films, for use in packaging or other applications where exposure to steam is undesirable.

Some ethylene vinyl alcohol or ethylene vinyl acetate polymers and blends thereof may be useful to prevent stress cracking fatigue resistance, including an ethylene vinyl alcohol polymer and a polymer of ethylene with at least one selected from the group consisting of alpha olefin having at least 2 carbon atoms, and an ethylenically unsaturated carboxylic ester monomer. Some ethylene vinyl acetate or ethylene vinyl alcohol polymers and blends thereof may provide useful flexible products.

Some ethylene vinyl alcohol and ethylene vinyl acetate polymers also form microporous materials. Articles formed therefrom may have internal structures of a multiplicity of spaced, randomly dispersed, non-uniform shaped particles of ethylene vinyl alcohol copolymer. Such internal structures may form a network of interconnected micropores thereby providing useful membranes or ion exchange materials.

The following examples are presented to exemplify embodiments of the invention and should not be construed to limit the invention as otherwise described herein. All numerical values may be considered approximate. When numerical ranges are given, it is understood that embodiments outside the stated ranges may still fall within the scope of the invention. Specific details described in each example should not be construed as necessary features of the invention.

### EXAMPLES

### Ring-Opening Metathesis Polymerization (Romp) of Cycloolefin

In one example, all glassware was dried overnight at 110° C., then assembled, while still hot, under a stream of nitrogen. A 2-L flask was loaded with 125.3 grams of cyclooctene and 1350 mL of THF. 1-hexene (0.1110 grams) was also added as a chain terminator to control the molecular weight of the polymer. In a nitrogen-filled dry box, a glass bottle was charged with bis(tricyclohexylphosphine)benzylidene ruthenium(IV) dichloride (Grubb's catalyst, 0.6219 g, 0.756 mmoles). The catalyst was dissolved in 25 mL of TBF and was transferred to the reaction flask. Another 25 mL of TBF was used to facilitate complete transfer of the catalyst. The reaction mixture was stirred briskly at room temperature, changing from a purple color to a deep brown color. After about 80 hours, the reaction was terminated by the addition of 1.0 mL of ethyl vinyl ether. A sample of the reaction mixture was analyzed by GPC, which indicated Mₙ=118,500, M_{w}=156,300, and MWD=1.32.

The polymer solution was diluted to 3 L with THF. To it was added 75 g of activated basic alumina, and the slurry was stirred for 1 hour and allowed to settle for 1 hour. The supernatant solution was decanted from the alumina and was centrifuged to produce a clear solution. The solids were combined and rinsed with THF, and the rinse was centrifuged and added to the polymer solution. The solution was concentrated on a rotary evaporator, and the last of the solvent was removed in a vacuum oven at 30° C. A blue-gray rubbery product was recovered, yield 118.1 g, 94%. FTIR: 3005.5 cm⁻¹, ═C—H; 2924.5 and 2852.9 cm⁻¹, —C—H; 1460.7 cm⁻¹; 966.8 cm⁻¹. There was no discernible C═C band in the range of 1600-1700 cm⁻¹.

In another experiment, all glassware was dried and assembled as discussed above. A 1-L 3-neck flask was charged with 109.48 g (993.5 mmoles) of cyclooctene and 400 mL of methylene chloride to which no stabilizer had been added. Another 5 mL of methylene chloride and 137 μL (0.0926 g, 1.1 mmoles) of 3-hexene were placed in a septum sealed glass vial, and this mixture was transferred with a syringe into the cyclooctene solution. In a nitrogen-filled dry box, 0.0413 g, (50.2 μmoles) of Grubb's catalyst was placed into a glass vial and dissolved in 10 mL of methylene chloride. This solution was transferred by syringe to the cyclooctene solution and the reaction mixture was stirred at room temperature overnight. After approximately 20 hours, 2 mL of ethyl vinyl ether was added, followed 1 hour later by a solution of 1 g of the antioxidant 2,6-di-tert-butyl-4-methylphenol (BHT) in 100 mL of methylene chloride. The polymer solution was poured into a stirred mixture of 3 L of methanol and 60 mL of concentrated HCl. The solid material was isolated by filtration and subsequently dried at 50° C. under vacuum.

The dried polymer was then dissolved in 1 L of methylene chloride that contained 0.9 g of BHT before being reprecipitated into approximately 6 L of vigorously stirred methanol. The resulting solids were washed with methanol and dried at 40° C. under vacuum. Recovered 87.0 g (79%) of polyoctenylene, Mₙ=184,600, M_{w}=308,600 (polystyrene standards), Mw/Mn=1.67.

In yet another experiment, the above described process was repeated using 11.042 g (100.2 mmoles) of cyclooctene, 24 μL (0.0163 g, 0.194 mmoles) of 3-hexene, 0.0099 g (12.0 μmoles) of the Grubb's catalyst and 40 mL of methylene chloride. After a similar workup, 9.3 g (84%) of polyoctylene was recovered. Mₙ=107,200 (GPC), M_{w}=153,300, Mw/Mn=1.43.

### Hydroboration and Hydroxylation of Cycloolefin Polymer

A 5-L glass reactor was charged with 58.8 g of polyoctenylene (0.533 C═C equiv.). The reactor was evacuated and back-filled with nitrogen, and then 1.5 L of anhydrous THF was added. The mixture was stirred and heated to a reflux to mostly dissolve the polymer. After the mixture had been cooled to room temperature, 1.1 L of 9-borabicyclo[3.3.1]nonane (9-BBN, 0.5M solution in THF, 0.55 moles) was added. The reaction mixture became a nearly clear, slightly yellow solution. It was heated to reflux at about 65° C. After 5 hours, an additional 1.0 L of 9-BBN solution (0.50 moles) was added, and reflux was continued overnight. The next day, the reaction mixture was cooled to <5° C. To it was added 230 mL (1.38 moles) of 6N NaOH during about 30 minutes. Gas evolved during the addition of NaOH, but the temperature did not rise appreciably. Then, while maintaining the temperature at <10° C., 465.8 g (4.11 moles) of 30% hydrogen peroxide was added. This addition was done very slowly during about 4 hours to control the heat that was generated. Large amounts of solid formed in the mixture during the addition. The temperature was held at <5° C. for another hour, and then the mixture was heated to 50° C. overnight. Upon heating, the solids dissolved.

The next day, the reaction mixture was cooled to room temperature. The polymer was precipitated in water (approximately 7:1 volume ratio), vacuum filtered, washed twice with water, and dried in a vacuum oven at 40° C. The dried product was dissolved in 1.6 L of THF, then precipitated in acetone (6:1 volume ratio). After being dried at 35° C. under vacuum, 59.4 g of Ethylene vinyl alcohol polymer was recovered (87% yield). FTIR: 3367.2 cm⁻¹, O—H; 2925.2 and 2851.2 cm⁻¹, —C—H; 1465.8 cm⁻¹. There was no band visible at 3000-3005 cm⁻¹, indicating the absence of C═C groups. DSC: T_{g}=33.3° C.; Tₘ=122.4° C. (47.03 J/g).

In another experiment, the hydroboration was carried out under nitrogen in a 5 L cylindrical, jacketed glass reactor. This reactor was charged with a solution of 42.5 g of polyoctenylene (approximately 386 meq of C═C) in 1170 mL of anhydrous tetrahydrofuran (THF). 9-BBN (800 mL 0.5N solution in THF) was added to the polyoctenylene solution. Approximately 5 hours later, an additional 800 ml of 0.5N 9-BBN was added to the reaction mixture. The mixture was heated and stirred overnight. After cooling the mixture to 5° C., 211.4 g of 6N NaOH solution and 454 g of THF were added. This was followed by the drop-wise addition of 30% hydrogen peroxide (360.0 g, 3.18 mmoles) at a rate sufficient to keep the reaction mixture below 20° C. When the addition was complete, the mixture was heated to 30° C. for 3 hours and then heated to 55 ° C. overnight. The polymer was precipitated from the warm mixture by the addition of 10 volumes of water with vigorous stirring. The obtained solid was vigorously stirred and washed 3 times with 2500 mL of water before being filtered and dried at 40° C. under vacuum. The dried polymer was slurried with 1250 mL of methanol in a distillation rig, and was heated until approximately 100 mL of distillate was collected. The liquid was decanted from the polymer and replaced with 1250 mL of methanol before repeating the distillation. The solids were collected and dried at 50° C. under vacuum. Recovered 46.3 g (94%) of ethylene vinyl alcohol polymer.

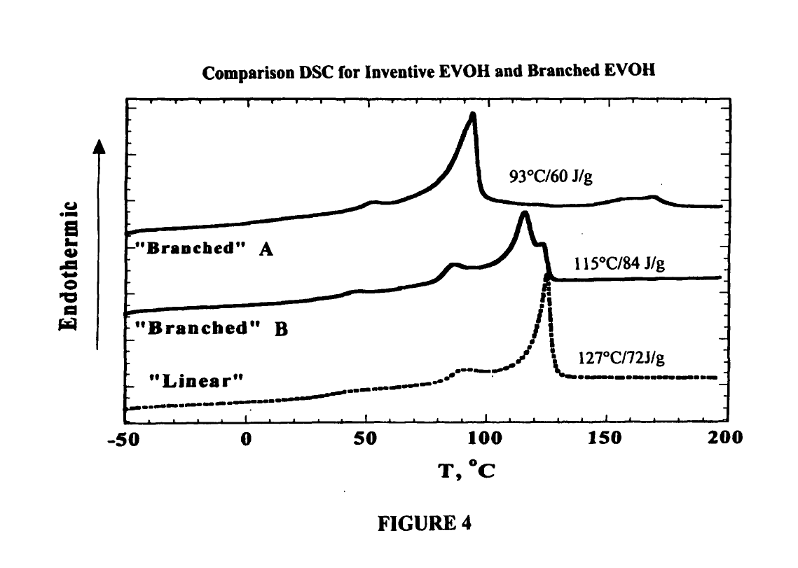

FIG. 4 shows the DSC behavior of an inventive ethylene vinyl alcohol polymer having 25 mol percent vinyl alcohol and a comparative branched ethylene vinyl alcohol. In FIG. 4, and the remaining discussion and Figures herein, samples designated “Branched A” are an ethylene vinyl alcohol having 25 wt. percent vinyl alcohol commercially available from Polyscience, Inc and samples designated “Branched B” are an ethylene vinyl alcohol with 34 wt. percent (25 mol percent) vinyl alcohol synthesized by hydrolysis of a ethylene vinyl acetate polymer. Branched C is a 67 wt. percent branched ethylene vinyl alcohol commercially available from Aldrich Chemical Company. As FIG. 4 indicates, the inventive polymer has an endothermic melting peak at about 125° C. which is higher than that of comparative branched ethylene vinyl alcohol samples. Other inventive ethylene vinyl alcohol polymers have an endothermic melting peak ranging from about 70° to about 150° C.

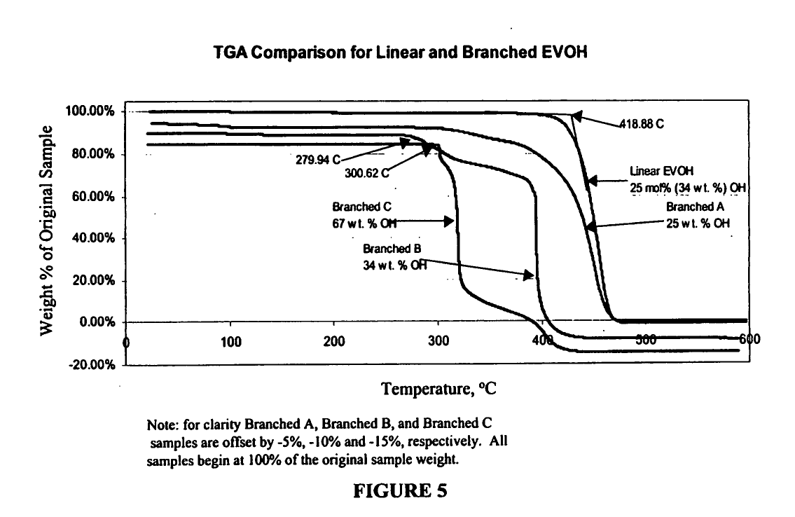

Thermal Gravimetric Analysis (TGA) measurements were performed on an inventive ethylene vinyl alcohol as described above. The analysis was performed using a du Pont 2100 Themorgravimetric Analyzer at a heating rate of 10° C./min from 20-600° C. The data for the inventive sample having about 25 mol percent vinyl alcohol and comparative samples are graphically represented in FIG. 5. As FIG. 5 indicates, the polymer is more stable at elevated temperatures while the branched counterparts having varying amounts of vinyl alcohol decompose at much lower temperatures. In some embodiments the ethylene vinyl alcohol polymer have an onset of decomposition that is greater than about 305° C., greater than about 310° C., greater than about 320° C., or greater than about 325° C. In other embodiments, the polymers begin to decompose at a temperature of about greater than 350° C., greater than about 360° C., greater than about 370° C., or greater than about 380° C. In still other embodiments, the polymer begins to decompose at temperatures of greater than about 390° C., 400° C. or about 420° C. Some polymers may have decomposition temperatures higher than 420° C. Thus, some such polymers may be useful in applications where other polymers would be unsuitable.

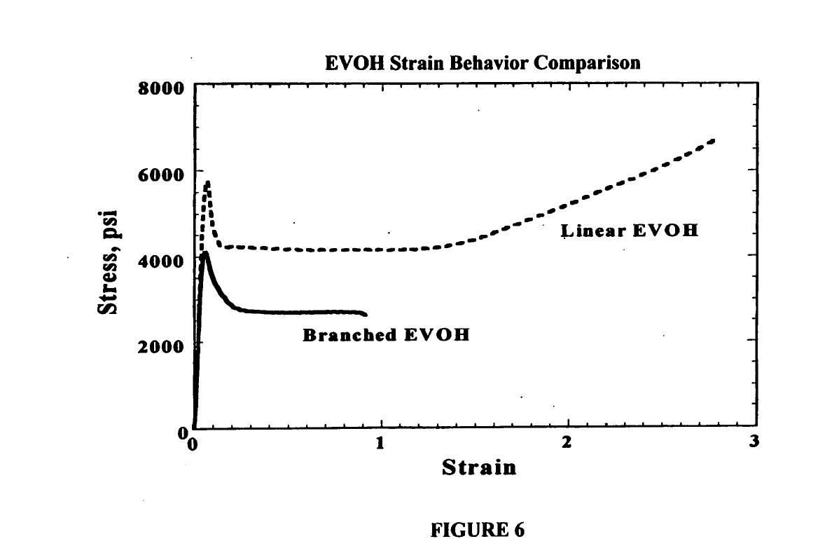

FIG. 6 illustrates the stress-strain behavior of an inventive sample of ethylene vinyl alcohol and a comparative branched sample. In FIG. 6 and the following figures, the inventive sample is labeled “Linear” for convenience. The term linear should be interpreted in a manner consistent with the novel polymers described herein. As FIG. 6 indicates, the comparative branched sample pulled an initial load of between about 4000 psi to about 4250 psi. After the initial load, the comparative sample shows a drawing stage that begins at a strain of about 0.2 and a stress of about 2750 psi and lasts until the sample fails at a strain of about 0.8. the comparative EVOH sample shows no strain hardening region.

FIG. 6 also shows the strain behavior of an embodiment of the linear EVOH polymers described herein. In the exemplary linear EVOH polymer, the sample pulled an 5 initial load of between about 5500 and about 6000 psi. The drawing stage of the sample occurs over the range of strain values of from of about 0.2 to about 1.4. In the drawing stage, the polymer carries a stress of between about 4000 psi and about 4500 psi. The drawing stage is followed by the strain hardening region, which occurs over the range of strain of from about 1.4 to about 2.8, wherein the sample breaks. In the strain hardening region, the lower end of the region has a strain of from about 4000 psi to about 4500 psi while the stress where the sample breaks is about 6500 psi to about 7000 psi. In other embodiments, the linear EVOH polymers described herein may have stress-strain properties outside those specifically recited. The strain behavior as illustrated in FIG. 6 indicates that inventive linear ethylene vinyl alcohol polymers are useful in high stress and strain applications.

The oxygen permeance of samples of ethylene vinyl alcohol polymer according to the invention was investigated. Samples 1-3 of the ethylene vinyl alcohol polymer according to the invention contained about 25 mol % vinyl alcohol. Oxygen permeability tests were conducted according to ASTM D3985-81 at an oxygen concentration of 100% as a function of the relative humidity (RH %). These data are collected in Table I. As Table I indicates, the oxygen permeability coefficient of the ethylene vinyl alcohol polymer described herein is substantially independent of humidity.

TABLE I

| | | | | | |
|---|---|---|---|---|---|
| RH | RH | O₂ Permeability | Avg | | |
| % | % | Coefficient (cc * mil)/ | Temp. | Avg | Range of |
| N₂ | O₂ | (100 in² * day * atm 0₂) | ° C. | Thickness | Thickness |

Sample 1

| | | | | | |
|---|---|---|---|---|---|
| dry | dry | 6.96 | 23 | 11.23 | 10.03-12.68 |
| 36 | 38 | 6.40 | 23 | 11.23 | 10.03-12.68 |
| 50 | 52 | 6.18 | 23 | 11.23 | 10.03-12.68 |
| 70 | 70 | 6.18 | 23 | 11.23 | 10.03-12.68 |
| 90 | 89 | 6.06 | 23 | 11.23 | 10.03-12.68 |

Sample 2

| | | | | | |
|---|---|---|---|---|---|
| dry | dry | 9.62 | 23 | 15.77 | 14.80-16.90 |
| 34 | 35 | 8.89 | 23 | 15.77 | 14.80-16.90 |
| 49 | 49 | 8.37 | 23 | 15.77 | 14.80-16.90 |
| 71 | 70 | 8.27 | 23 | 15.77 | 14.80-16.90 |
| 90 | 91 | 8.15 | 23 | 15.77 | 14.80-16.90 |

Sample 3

| | | | | | |
|---|---|---|---|---|---|
| dry | dry | 9.51 | 23 | 15.15 | 12.15-17.78 |
| 34 | 35 | 8.68 | 23 | 15.15 | 12.15-17.78 |
| 49 | 49 | 8.19 | 23 | 15.15 | 12.15-17.78 |
| 71 | 70 | 8.05 | 23 | 15.15 | 12.15-17.78 |
| 90 | 91 | 7.73 | 23 | 15.15 | 12.15-17.78 |

Comparative Sample 4*

| | | | | | |
|---|---|---|---|---|---|
| dry | dry | 14.91 | 23 | 6.05 | 5.50-6.80 |
| 33 | 36 | 13.47 | 23 | 6.05 | 5.50-6.80 |
| 49 | 53 | 13.13 | 23 | 6.05 | 5.50-6.80 |
| 70 | 71 | 13.25 | 23 | 6.05 | 5.50-6.80 |
| 89 | 88 | 13.86 | 23 | 6.05 | 5.50-6.80 |

Comparative Sample 5*

| | | | | | |
|---|---|---|---|---|---|
| dry | dry | 14.02 | 23 | 6.36 | 5.70-6.93 |
| 33 | 36 | 12.75 | 23 | 6.36 | 5.70-6.93 |
| 48 | 53 | 12.43 | 23 | 6.36 | 5.70-6.93 |
| 70 | 71 | 12.52 | 23 | 6.36 | 5.70-6.93 |
| 89 | 88 | 12.99 | 23 | 6.36 | 5.70-6.93 |

Comparative Sample 6*

| | | | | | |
|---|---|---|---|---|---|
| dry | dry | 15.57 | 23 | 4.95 | 4.45-5.45 |
| 36 | 38 | 14.06 | 23 | 4.95 | 4.45-5.45 |
| 50 | 52 | 13.66 | 23 | 4.95 | 4.45-5.45 |
| 70 | 70 | 13.66 | 23 | 4.95 | 4.45-5.45 |
| 90 | 89 | 14.16 | 23 | 4.95 | 4.45-5.45 |

Comparative Sample 7^{†}

| | | | | | |
|---|---|---|---|---|---|
| 35 | 38 | 130 | 23 | 7.13 | 6.23-7.55 |
| 90 | 90 | 152 | 23 | 7.13 | 6.23-7.55 |

Comparative Sample 8^{†}

| | | | | | |
|---|---|---|---|---|---|
| 35 | 38 | 130 | 23 | 6.30 | 5.58-6.75 |
| 90 | 90 | 152 | 23 | 6.30 | 5.58-6.75 |

*Branched B: EVOH copolymer (25 mol % OH) prepared by hydrolizing a commercial EVA copolymer
^{†}Branched A: Commercial Branched EVOH copolymer 25 wt % OH

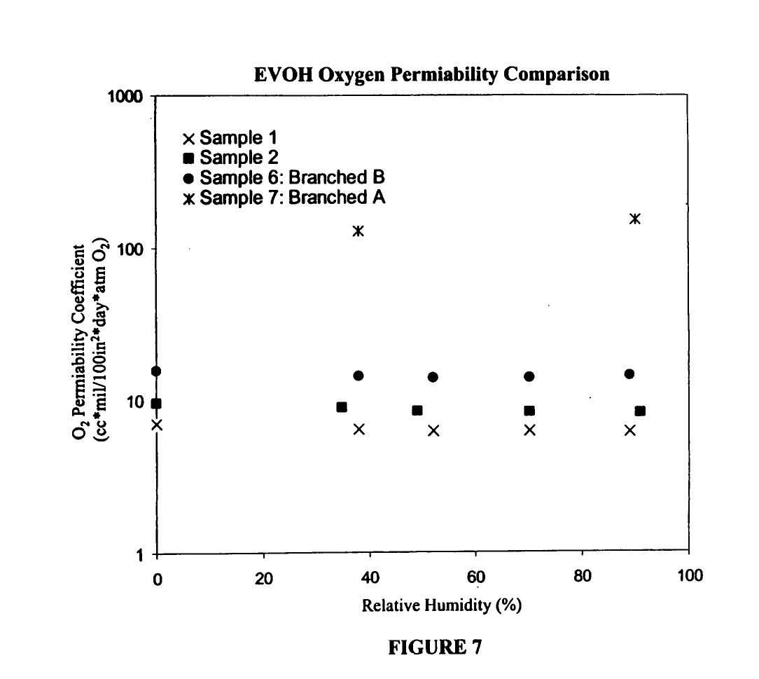

FIG. 7 represents a graphical illustration of the data in Table I plotted as a function of the relative humidity. As FIG. 7 shows, the oxygen permeability coefficient for the linear EVOH polymers made in accordance with embodiments of the invention is substantially independent of the humidity. The O₂ permeability coefficient of each of the linear EVOH samples is also lower than that of any of the comparative samples. Other polymers described herein have an oxygen permeability coefficient that is less than about 5, about 4, or about 3 (cc*mil)/(100 in²*day*atm O₂). Thus, these materials are useful as membranes for controlling oxygen transmission in a variety of environments, especially those where continuous control of humidity is difficult. Some inventive ethylene vinyl acetate polymers may show similar behavior.

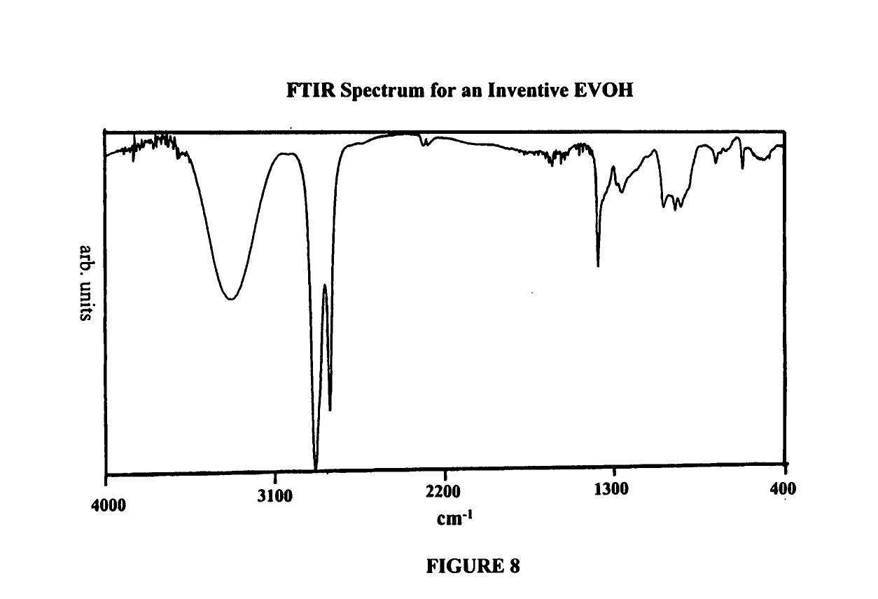

The inventive ethylene vinyl alcohol polymers are characterized using standard methods for characterizing organic compounds. FIG. 8 depicts the Fourier Transform Infrared Spectrum of an inventive ethylene vinyl alcohol polymer. The broad peak at low frequency in the spectrum of the ethylene vinyl alcohol of FIG. 8 is due at least in part to the hydroxyl groups of the polymer.

### Acetylation of Ethylene Vinyl Alcohol Polymer

A 3-L flask was charged with 59.4 g of linear ethylene vinyl alcohol polymer (0.46 OH equiv.) and 1665 mL of 1,4-dioxane. The mixture was stirred under nitrogen and heated using infrared heat lamps until the solids became swollen and translucent. Acetic anhydride (220 mL, 238 g, 2.3 moles) and pyridine (47 mL, 46 g, 0.58 moles) were added, and heating was continued to effect dissolution. Next day, the clear amber solution was cooled to about room temperature. The product was precipitated in hexane (12:1 volume ratio), and the yellow-tan, gummy polymer was dried in a vacuum oven at room temperature. After partial drying, the polymer was cut into smaller pieces and was dried in a vacuum oven at 40° C. The recovered yield was 57.8 g, 73%. No thermal events were observed by differential scanning calorimetry between 30° C. and 200° C.

In another experiment, a 3 L, 4-neck flask was charged with 46.0 g of ethylene vinyl alcohol polymer (359 meq of OH) and 1334 g of 1,4 dioxane. The mixture was stirred and heated to 95° C. using infrared lamps to dissolve the polymer. When all the polymer had dissolved, acetic anhydride (368.0, 3.61 mmoles) and pyridine (17.9 g, 227 mmoles) were added to the polymer solution. The temperature was then reduced to 90° C. and the solution was stirred overnight. After cooling to room temperature, the solution was concentrated to ⅔ of its original volume by rotary evaporation. The polymer was precipitated from the solution with vigorous stirring in 5 volumes of hexane. The solids were then dissolved in 1154 g of 1,4 dioxane at 50° C. and reprecipitated with 9 volumes of hexane. The solids were collected and washed with hexane with vigorous stirring before being dried at 46° C. under vacuum. Recovered 51.1 g (84%) of ethylene vinyl acetate polymer.

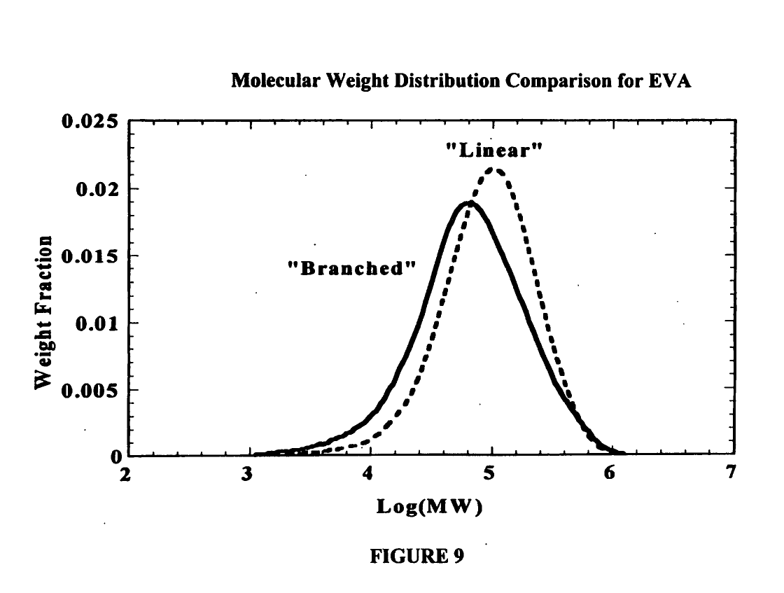

FIG. 9 illustrates the molecular weight distribution of one inventive ethylene vinyl acetate polymer having about 25 mol percent of vinyl acetate and a corresponding branched ethylene vinyl acetate polymer. The linear ethylene vinyl acetate polymer has both a higher molecular weight (M_{w}) and a narrower distribution than that of the branched counterpart. Polymers having a narrower weight distribution often advantageously possess better mechanical properties, such as tensile strength, when compared with those having a broader molecular weight distribution.

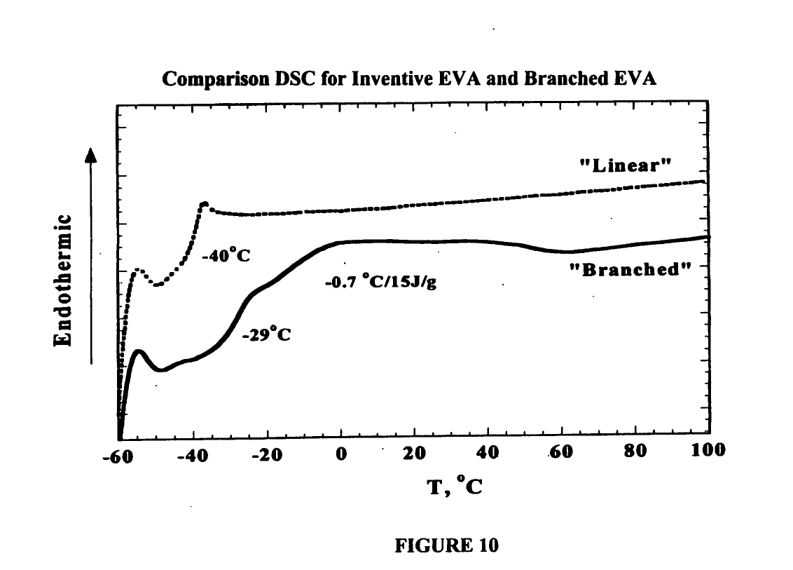

FIG. 10 illustrates the DSC behavior of an inventive ethylene vinyl acetate polymer having 25 mol percent vinyl acetate having an absence of a melting exotherm and the comparative DSC behavior of a comparable branched ethylene vinyl acetate polymer. The lack of structure in the DSC scan from about −40° C. to 200° C. also indicates that this inventive ethylene vinyl acetate polymer lacks crystallinity.

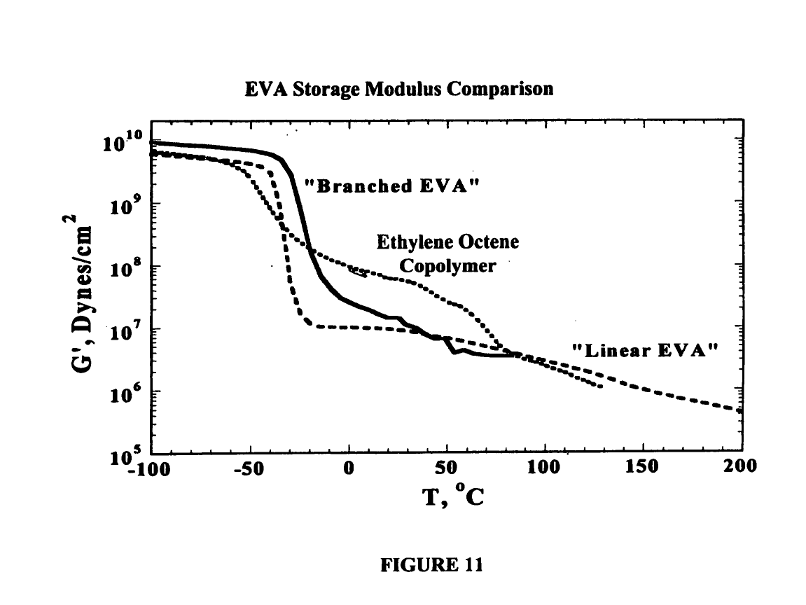

FIG. 11 depicts the behavior of a the storage modulus of an ethylene vinyl acetate polymer having 25 mol percent vinyl acetate. Unlike, branched ethylene vinyl acetate polymers, this inventive polymer has a measurable storage modulus at 200° C. indicating its suitability for use in applications requiring temperatures that cause branched counterparts to fail.

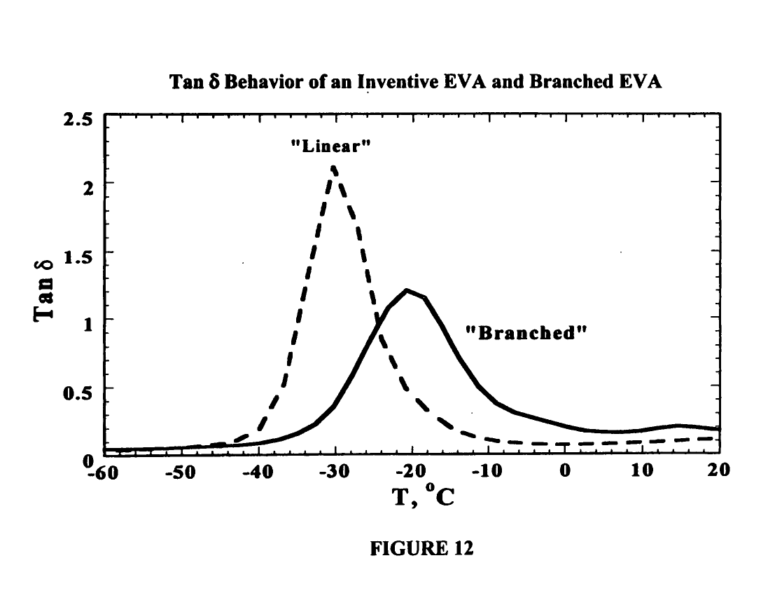

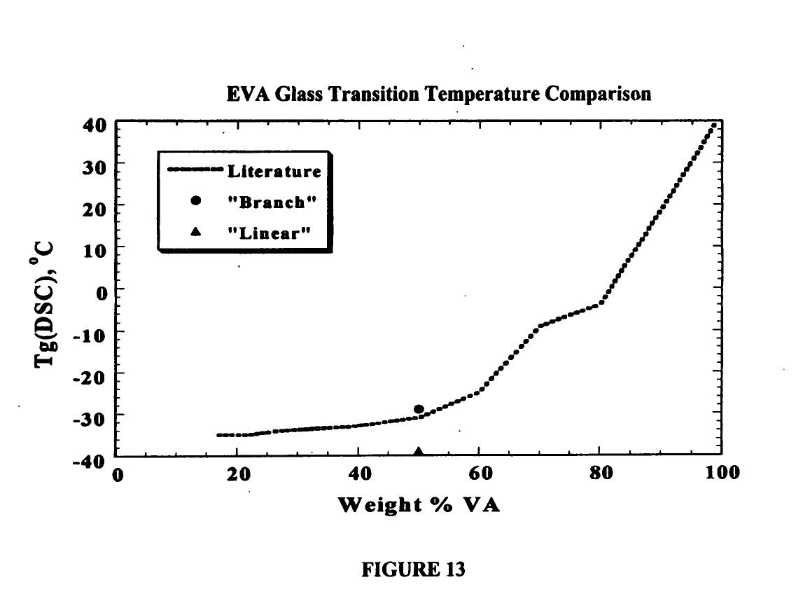

FIG. 12 illustrates the relationship between tan δ and temperature for an inventive ethylene vinyl acetate polymer having 25 mol percent vinyl acetate and its branched counterpart. As FIG. 12 indicates, this inventive ethylene vinyl acetate polymer displays a glass transition temperature of about −40° C. as measured by the onset of the transition in the Tan δ plot. The comparative branched ethylene vinyl acetate polymer has a glass transition temperature (T_{g}) that occurs at about −30° C. FIG. 13 compares the glass transition temperatures of an inventive ethylene vinyl acetate polymer having 50 weight percent vinyl acetate with that of a branched ethylene vinyl acetate and the values expected from the literature. The linear ethylene vinyl acetate polymer has a transition temperature of about −40° C. This value is about 10-15° C. lower than the branched polymer and the literature value at the same vinyl acetate content. Other polymers described herein may have a glass transition temperature that is at least about 5° C., about 10° C., or about 20° C. lower than comparative branched or other EVA polymers having about the same vinyl acetate content. Linear ethylene vinyl acetate polymers may alternatively be described as having a glass transition temperature that is about 1%, about 2%, about 5% lower than a branched ethylene vinyl acetate having the same composition. In other embodiments, the linear ethylene vinyl acetate polymers may be characterized by a glass transition temperature that is about 10%, about 15% or about 20% lower than that of a branched counterpart having the same vinyl acetate content. One skilled in the art realizes that relative temperature comparisons must be based on absolute temperatures.

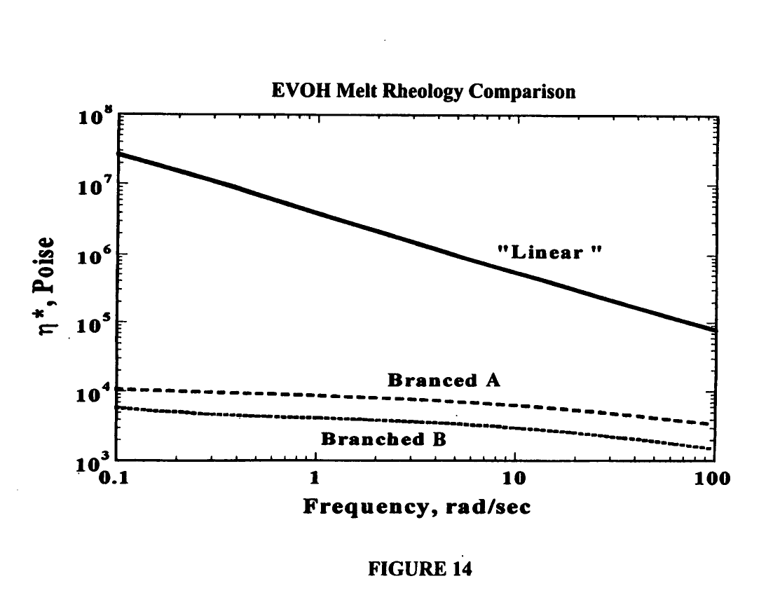

The dependence of the viscosity on shear frequency for an inventive ethylene vinyl acetate polymer is illustrated in FIG. 14. The viscosity of the inventive sample of ethylene vinyl acetate ranges from about 1.2×10⁵ at 0.1 rad/s to about 1.1×10⁴ at 100 rad/s. Over the range from 0.1 rad/s to 100 rad/s the inventive sample has a higher viscosity. However, the change in the viscosity as a function of the shear frequency is comparable to that of a comparable branched ethylene vinyl acetate polymer.

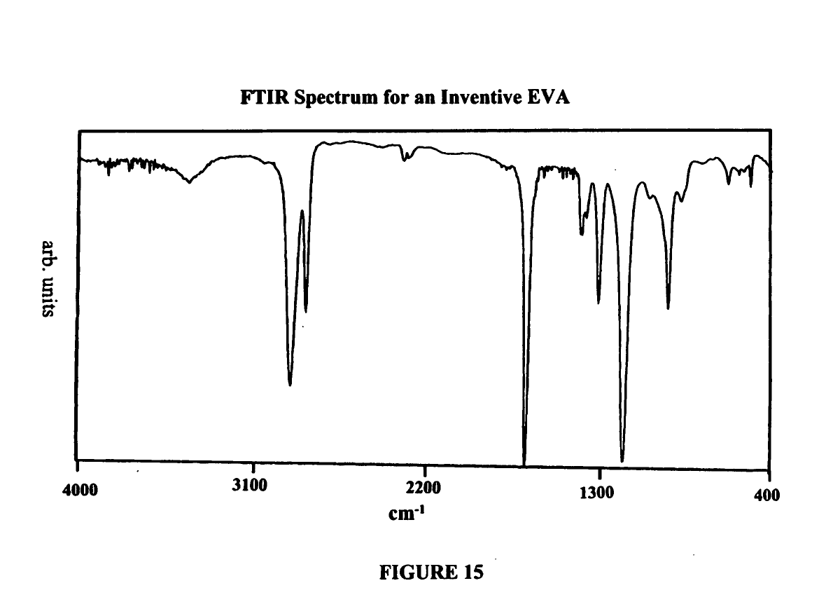

FIG. 15 shows the infrared spectrum (FT-IR) of an inventive ethylene vinyl acetate polymer. In contrast to the infrared spectrum of ethylene vinyl alcohol, a peak indicating OH is substantially absent in FIG. 15 and has been replaced by peaks generally associated with ester groups.

While the invention has been described with a limited number of embodiments, these specific embodiments are not intended to limit the scope of the invention as otherwise described and claimed herein. Modification and variations from the described embodiments exist. It is understood that parameters of polymerization processes may vary, for example, in temperature, pressure, monomer concentration, polymer concentration, and so on. Therefore, catalysts which do not fulfill the selection criteria under one set of reaction conditions may nevertheless be used in embodiments of the invention under another set of reaction conditions. While all of the embodiments are described with reference to a single catalyst, it by no means precludes the use of two, three, four, five, or more catalysts simultaneously in a single reactor with similar or different capability for molecular weight and/or comonomer incorporation. It should be recognized that the process described herein may be used to make ethylene vinyl alcohol and ethylene vinyl acetate polymers which also incorporate one or more additional comonomers. The incorporation of additional comonomers may result in beneficial properties which are not available to copolymers. While the processes are described as comprising one or more steps, it should be understood that these steps may be practiced in any order or sequence unless otherwise indicated. These steps may be combined or separated. Finally, any number disclosed herein should be construed to mean approximate, regardless of whether the word “about” or “approximate” is used in describing the number. Last but not the least, the claimed linear EVOH polymers and EVA polymers are not limited to the processes described herein. They can be prepared by any suitable process. The appended claims intend to cover all such variations and modifications as falling within the scope of the invention.

1. A polymer comprising repeating units of ethylene and vinyl alcohol, characterized by
a linear backbone with substantial absence of branching on the backbone; and
a steady state oxygen permeability coefficient substantially independent of the humidity, a strain hardening region, or a combination thereof.

2. A polymer comprising repeating units of ethylene and vinyl acetate, characterized by
a linear backbone with substantial absence of branching on the backbone;
a plurality of acetate groups bonded to the backbone, the acetate groups being separated by x-2, x-1 or x carbon atoms and present in a ratio of 1:2:1, wherein x is an integer equal to or greater than 3.

3. The polymer of claim 1 or 2, wherein the polymer has a vinyl alcohol or vinyl acetate content of about 1 mol. % to about 75 mol. %.

4. The polymer of claim 1, wherein the polymer has a plurality of hydroxyl groups bonded to the backbone, the hydroxyl groups being separated by x-2, x-1 or x carbon atoms and present in a ratio of 1:2:1, wherein x ranges integrally from 3 to about 12.

5. The polymer of claim 2, wherein the polymer has a strain hardening region.

6. The polymer of claim 1 or 5, wherein the polymer is characterized by a slope of strain hardening coefficient of about 0.1 to about 10.

7. The polymer of claim 1 or 2, wherein the polymer has a molecular weight distribution of less than 5.

8. The polymer of claim 1 or 2, wherein the polymer has a molecular weight distribution of less than 3.

9. The polymer of claim 1 or 2, wherein the polymer has a molecular weight distribution of less than 2.

10. The polymer of claim 1 or 2, wherein the polymer has an oxygen permeability coefficient of less than 10 cc*mil/100 in²*day*atm.

11. The polymer of claim 1 or 2, wherein the polymer has an oxygen permeability coefficient of less than 8 cc*mil/100 in²*day*atm.

12. The polymer of claim 1 or 2, wherein the backbone has less than about 0.01 long-chain branch/1000 carbon atoms.

13. The polymer of claims 1 or 2, further characterized by an elongation at break of greater than about 100%.

14. The polymer of claims 1 or 2, further characterized by a one or both of maximum load of greater than about 4200 psi.

15. The polymer of claims 1 or 2, further characterized by an energy to break of greater than about 50 lb*in.

16. The polymer of claim 1, wherein the polymer is a copolymer consisting essentially of repeating units of ethylene and vinyl alcohol.

17. The polymer of claim 2, wherein the polymer is a copolymer consisting essentially of repeating units of ethylene and vinyl acetate.

18. The polymer of claim 1, wherein the polymer has a decomposition temperature of greater than about 305° C.

19. The polymer of claim 2, wherein the polymer has a glass transition temperature of less than about −30°.

20. A process for making a linear polymer of ethylene an vinyl alcohol, comprising:
contacting an unsubstituted cycloolefin with a compound represented by formula I: 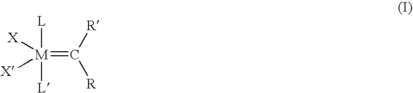
to make a precursor polymer having olefinic unsaturation;
wherein M is selected from the group consisting of Os and Ru;
R and R′ are independently selected from the group consisting of hydrogen and a substituent group selected from the group consisting of C₁-C₂₀ alkyl, C₂-C₂₀ alkenyl, C₂-C₂₀ alkoxycarbonyl, aryl, C₁-C₂₀ carboxylate, C₁-C₂₀ alkoxy, C₂-C₂₀ alkenyloxy, C₂-C₂₀ alkynyloxy and aryloxy; the substituent group optionally substituted with a moiety selected from the group consisting of C₁-C₅ alkyl, halogen, C₁-C₅ alkoxy, and phenyl; the phenyl optionally substituted with a moiety selected from the group consisting of halogen, C₁-C₅ alkyl, and C₁-C₅ alkoxy;
X and X′ are independently selected from any anionic ligand; and
L and L′ are independently selected from any phosphine of the formula PR³R⁴R⁵, wherein R³ is selected from the group consisting of neophyl, secondary alkyl and cycloalkyl, and R⁴ and R⁵ are independently selected from the group consisting of aryl, neophyl, C₁-C₁₀ primary alkyl, secondary alkyl, and cycloalkyl;
contacting the precursor polymer with a boron-containing compound capable of hydroborating the olefinic unsaturation to form an intermediate polymer; and
contacting the intermediate polymer with a mixture comprising an oxidizing agent to produce a polymer comprising repeating units of ethylene and vinyl alcohol.

21. The process as recited in claim 20 further including converting the ethylene vinyl alcohol polymer to an ethylene vinyl acetate polymer.

22. The process as recited in claim 20 or 21 wherein the boron-containing compound is 9-borabicyclo[3.3.1)]nonane.

23. The process as recited in claim 20 or 21 the oxidizing agent is hydrogen peroxide.

24. The process as recited in claim 22 wherein the oxidizing agent further includes a hydroxide source.

25. The process as recited in claim 20 or 21 wherein the cycloolefin includes from 3 to about 10 carbon atoms per molecule.

26. The process as recited in claim 20 wherein the ethylene vinyl alcohol polymer includes a plurality of hydroxyl groups bonded to the backbone of the polymer, the hydroxyl groups being separated by x-2, x-1 or x carbon atoms, and being present in a ratio of 1:2:1, wherein x ranges integrally from 3 to 12.

27. The process as recited in claim 20 or 21 wherein the ethylene vinyl alcohol polymer has a steady state oxygen permeability coefficient substantially independent of the humidity.

28. The process as recited in claim 21 wherein the ethylene vinyl alcohol polymer is contacted with acetic anhydride to obtain the ethylene vinyl acetate polymer.
